(19) United States
(12) Patent Application Publication
(10) Pub. No.: US 2018/0052500 A1
(43) Pub. Date: Feb. 22, 2018

(54) ELECTRONIC DEVICE

(71) Applicant: AOpen Inc., New Taipei City (TW)

(72) Inventors: JO-CHIAO WANG, New Taipei City (TW); CHIH-TIEN CHENG, New Taipei City (TW); CHIEN-HUI CHEN, New Taipei City (TW); CHING-HUNG YANG, New Taipei City (TW)

(21) Appl. No.: 15/340,057

(22) Filed: Nov. 1, 2016

(30) Foreign Application Priority Data
Aug. 18, 2016 (TW) 105126466

(51) Int. Cl. G06F 1/20; G06F 9/44; G06F 9/50

(52) U.S. Cl. CPC G06F 1/206; G06F 9/5094; G06F 9/4401

(57) ABSTRACT

An electronic device includes a chassis, a first thermal cover, and a second thermal cover. The chassis is assembled with a motherboard and a recognition device. The motherboard includes a basic input/output system (BIOS) and an electronic component. The BIOS is electrically connected to the electronic component. A first operation parameter and a second operation parameter adapted to the electronic component are preset in the BIOS. When the first thermal cover covers the chassis, the BIOS drives the electronic component to be operated according to the first operation parameter. When the second thermal cover covers the chassis, the BIOS drives the electronic component to be operated according to the second operation parameter.

### CROSS-REFERENCE TO RELATED APPLICATION

This non-provisional application claims priority under 35 U.S.C. § 119(a) to Patent Application No. 105126466 filed in Taiwan, R.O.C. on Aug. 18, 2016, the entire contents of which are hereby incorporated by reference.

### BACKGROUND

### Technical Field

The instant disclosure relates to an electronic device, in particular, to an electronic device capable of operating in a mode corresponding to the heat dissipating capacity of its thermal covers.

### Related Art

Along with the developments of technology, needs for computers gradually increases. For example, industrial computers were utilized in controlling, monitoring, or test procedures of automated productions of factories in the early days; nevertheless, since technology marches, applications of industrial computers become wider, and industrial computers can be utilized in, e.g., point of sale (POS) terminals, Kiosks, automated teller machines (ATM), digital boards, ticket reader systems in MRT (mass rapid transportation), automotive telematic devices, etc. Generally, during operation, the electronic components (for example, central processing unit, memory, display card, hard disk of the motherboard) in the industrial computer generate heats. In order to prevent the electronic components from unstably operating due to the increased accumulated temperature, industrial computers commonly are assembled with heat dissipation modules.

A conventional industrial computer includes a chassis, a motherboard assembled in the chassis, and a heat dissipation housing assembled on the chassis. The basic input/output system (BIOS) of the motherboard sets a system parameter corresponding to the heat dissipation capacity of the heat dissipation housing, so that the components can be operated according to the system parameter, and the electronic component can be kept in a moderate temperature. However, when the heat dissipating housing of an industrial computer is required to be replaced with one with different heat dissipation capacity (for example, when a user tends to change the appearance or the material of the heat dissipation housing), the industrial computers are required to be sent back to the factory for resetting the system parameter of the BIOS so as to adapt to the heat dissipation capacity of the new heat dissipation housing. As a result, replacement of the heat dissipation housing takes efforts and efficiency for the replacement is low.

### SUMMARY

In view of these issues, in one embodiment, an electronic device is provided. The electronic device comprises a chassis, a first thermal cover, and a second thermal cover. The chassis is assembled with a motherboard and a recognition device. The motherboard comprises a basic input/output system (BIOS) and an electronic component. A first operation parameter and a second operation parameter which are adapted to the electronic component are preset in the BIOS. The first thermal cover comprises a first triggering member. The second thermal cover comprises a second triggering member. The first thermal cover and the second thermal cover have different heat dissipation capacities. Wherein, the first thermal cover or the second thermal cover selectively covers the chassis. When the first thermal cover covers the chassis, the first triggering member corresponds to the recognition device, and the BIOS detects a connection state between the recognition device and the first triggering member to drive the electronic component to be operated according to the first operation parameter. When the second thermal cover covers the chassis, the second triggering member corresponds to the recognition device, and the BIOS detects a connection state between the recognition device and the second triggering member to drive the electronic component to be operated according to the second operation parameter.

According to embodiments, different operation parameters respectively corresponding to different thermal covers with different heat dissipation capacities can be preset in the BIOS. Accordingly, when the electronic device is assembled to a different thermal cover, (the BIOS can automatically select a corresponding operation parameter. Therefore, labor costs and operation times can be reduced.

### BRIEF DESCRIPTION OF THE DRAWINGS

The disclosure will become more fully understood from the detailed description given herein below for illustration only, and thus not limitative of the disclosure, wherein:

FIG. 1 illustrates an exploded view (1) of an electronic device according to a first embodiment of the instant disclosure;

FIG. 2 illustrates a partial sectional view of the electronic device shown in FIG. 1;

FIG. 3 illustrates an exploded view (2) of the electronic device according to the first embodiment of the instant disclosure;

FIG. 4 illustrates a partial sectional view of the electronic device shown in FIG. 3;

FIG. 5 illustrates a partial sectional view (1) of an electronic device according to a second embodiment of the instant disclosure;

FIG. 6 illustrates a partial sectional view (2) of the electronic device according to the second embodiment of the instant disclosure;

FIG. 7 illustrates a partial sectional view (1) of an electronic device according to a third embodiment of the instant disclosure;

FIG. 8 illustrates a partial sectional view (2) of the electronic device according to the third embodiment of the instant disclosure;

FIG. 9 illustrates a partial exploded view of the electronic device according to the third embodiment of the instant disclosure;

FIG. 10 illustrates a partial sectional view (1) of an electronic device according to a fourth embodiment of the instant disclosure;

FIG. 11 illustrates a partial sectional view (2) of the electronic device according to the fourth embodiment of the instant disclosure;

FIG. 12 illustrates a partial sectional view (1) of an electronic device according to a fifth embodiment of the instant disclosure; and

FIG. 13 illustrates a partial sectional view (2) of the electronic device according to the fifth embodiment of the instant disclosure.

### DETAILED DESCRIPTION

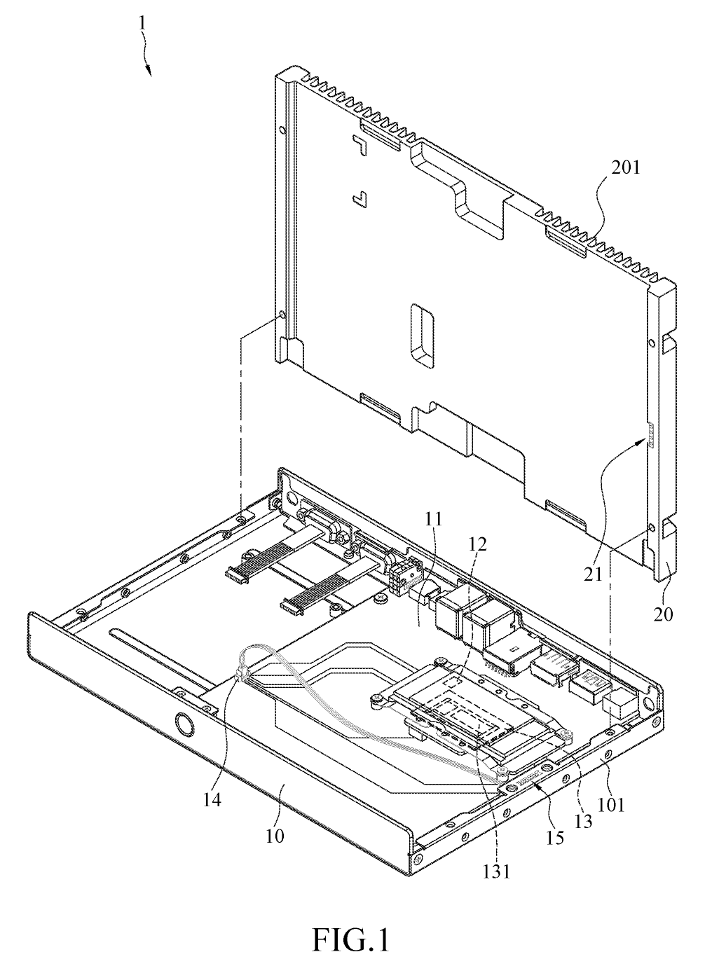

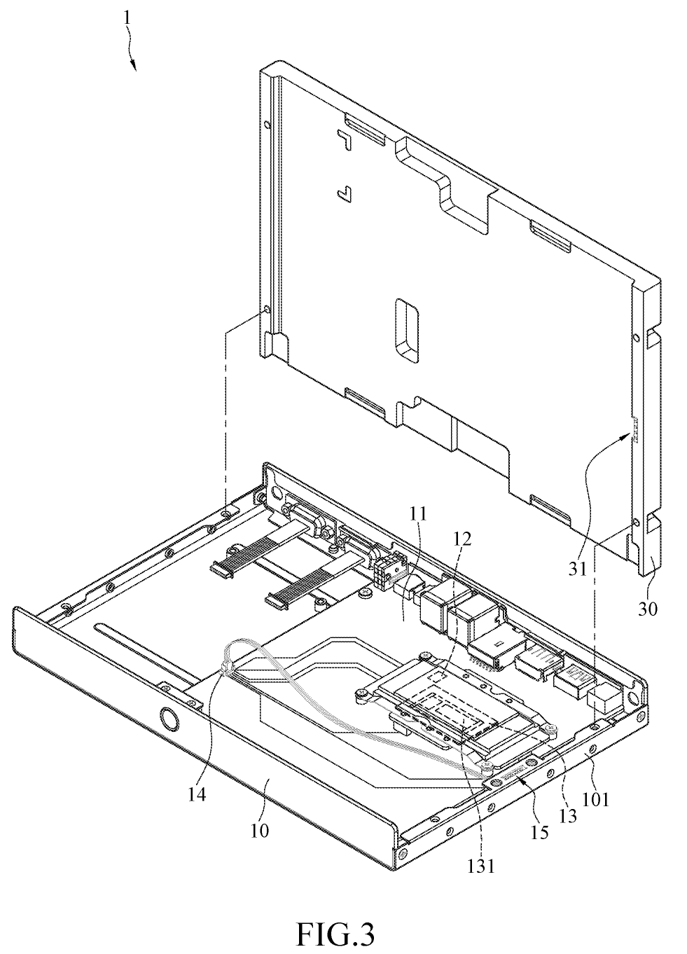

Please refer to FIGS. 1 and 3, respectively illustrating exploded views (1) and (2) of an electronic device according to a first embodiment of the instant disclosure. The electronic device 1 may be a computer (an industrial computer or a personal computer). The electronic device 1 comprises a chassis 10, a first thermal cover 20, and a second thermal cover 30. The chassis 10 is assembled with a motherboard 11 and a recognition device 15. In this embodiment, the motherboard 11 is assembled in the chassis 10, and the recognition device 15 is assembled on one of the side boards 101 of the chassis 10. In some embodiments, the recognition device 15 may be assembled in the chassis 10. The motherboard 11 comprises a basic input/output system (abbreviated as BIOS 12) and an electronic component 13. The electronic component 13 may be a central processing unit (CPU), a display card, a memory, or a heat dissipation fan assembled on the motherboard 11. As shown in FIGS. 1 and 3, in this embodiment, an input/output module (I/O module 14) may be assembled on the motherboard 11. The recognition device 15 is electrically connected to the I/O module 14 (e.g., the recognition device 15 may be connected to the I/O module 14 through cables). The I/O module 14 is electrically connected to the electronic component 13 (e.g., the I/O module 14 may be electrically connected to the electronic component 13 through wires of the motherboard 11). In addition, the BIOS 12 is electrically connected to the electronic component 13 to drive the electronic component 13 to be operated according to the parameter set by the BIOS 12.

Please refer to FIGS. 1 and 3. The BIOS 12 may be programmed in a chip and installed to the motherboard 11, and the BIOS 12 can set the operation parameters (e.g., operation speed or operation time) of the hardware of the electronic device 1. After the electronic device 1 is booted, the BIOS 12 drives the hardware of the electronic device 1 according to the operation parameters set by the BIOS 12. In this embodiment, a first operation parameter and a second parameter are preset in the BIOS 12, and the first operation parameter and the second operation parameter are adapted to the electronic component 13. In other words, the BIOS 12 has preset two or more different operation parameters for the electronic component 13.

As shown in FIGS. 1 and 3, the chassis 10 is selectively assembled with two or more different thermal covers. For the sake of convenience, in this embodiment, the chassis 10 is selectively assembled to two thermal covers, respectively, called a first thermal cover 20 and a second thermal cover 30. In other words, the chassis 10 may be selectively assembled with the first thermal cover 20 (as shown in FIG. 1) or the second thermal cover 30 (as shown in FIG. 3) based on different needs. Wherein, the first thermal cover 20 and the second thermal cover 30 have different heat dissipation capacities. For example, in this embodiment, the first thermal cover 20 has heat dissipation fins 201 yet the second thermal cover 30 does not have heat dissipation fins; hence, the heat dissipation capacity of the first thermal cover 20 is better than and different from that of the second thermal cover 30. In some embodiments, the first thermal cover 20 and the second thermal cover 30 may have different appearances or may be made of different materials so as to have different heat dissipation capacities. In addition, the first operation parameter set by the BIOS 12 of the motherboard 11 corresponds to the heat dissipation capacity of the first thermal cover 20, and the second operation parameter set by the BIOS 12 of the motherboard 11 corresponds to the heat dissipation capacity of the second thermal cover 30. For example, because the heat dissipation capacity of the first terminal cover 20 is better than that of the second thermal cover 30, the operation speed at which the electronic component 13 is driven according to the first operation parameter is greater than that according to the second operation parameter.

As shown in FIG. 1, a first triggering member 21 is assembled on the first thermal cover 20. In this embodiment, the first triggering member 21 is assembled on a side wall of the first thermal cover 20. When the first thermal cover 20 covers the chassis 10, the first triggering member 21 of the first thermal cover 20 corresponds to the recognition device 15 of the chassis 10, and the BIOS 12 can detect the connection between the recognition device 15 and the first triggering member 21 to identify the first thermal cover 20 is covering the chassis 10, so that the BIOS 12 drives the electronic component 13 to be operated according to the first operation parameter. As shown in FIG. 3, a second triggering member 31 is assembled on the second thermal cover 30. In this embodiment, the second triggering member 31 is assembled on a side wall of the second thermal cover 30. When the second thermal cover 30 covers the chassis 10, the second triggering member 31 of the second thermal cover 30 corresponds to the recognition device 15 of the chassis 10, and the BIOS 12 can detect the connection between the recognition device 15 and the second triggering member 31 to identify the second thermal cover 30 is covering the chassis 10, so that the BIOS 12 drives the electronic component 13 to be operated according to the second operation parameter.

For example, supposed that the chassis 10 is assembled with the first thermal cover 20 (as shown in FIG. 1); in this case, after the electronic device 1 is booted, the BIOS 12 drives the electronic component 13 by the preset first operation parameter to correspond to the heat dissipation capacity of the first thermal cover 20. When the first thermal cover 20 is required to be replaced by the second thermal cover 30 according to user's needs (for example, when the user tends to change the appearance or the material of the thermal cover), an operator (the user, the repairmen, etc.) can just detach the first thermal cover 20 off the chassis 10 and assemble the second thermal cover 30 on the chassis 10. Hence, the BIOS 12 will change the operation parameter for driving the electronic component 13 from the first operation parameter to the second operation parameter automatically so as to correspond to the heat dissipation capacity of the second thermal cover 30. Therefore, it is not necessary to take the electronic device 1 back to the factory for resetting the operation parameter corresponding to the second thermal cover 30. Accordingly, the electronic device 1 according to the embodiment provides not only a reduced labor cost but also quick and convenient operation for replacing the thermal cover and resetting the operation parameter. In some embodiments, the BIOS 12 can preset three or more different operation parameters for the electronic component 13 so as to adapted to more different thermal covers.

In the following paragraphs, embodiments are provided to describe how the BIOS 12 detects the connection state between the recognition device 15 and the first triggering member 21 and the connection state between the recognition device 15 and the second triggering member 31 to identify the chassis 10 is assembled with the first thermal cover 20 or the second thermal cover 30.

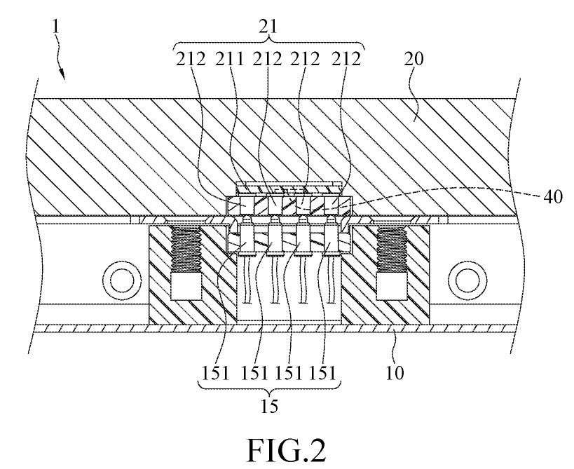

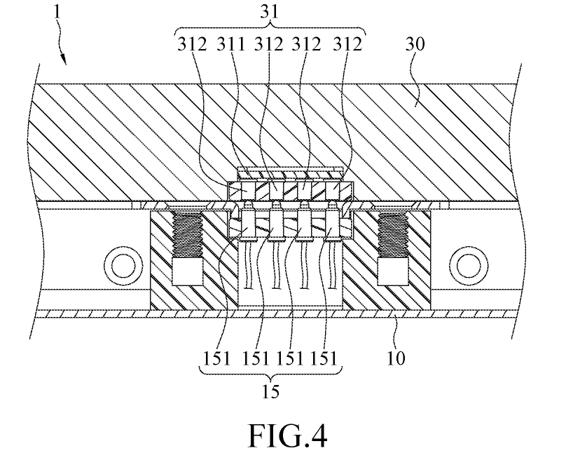

Please refer to FIGS. 1 and 2. FIG. 2 illustrates a partial sectional view of the electronic device shown in FIG. 1. Wherein, the recognition device 15 may further comprise one or more pogo pin connectors 151. For the sake of convenience, in this embodiment, the recognition device 15 comprises four pogo pin connectors 151, and the first triggering member 21 comprises a first circuit board 211 fixed assembled on a side wall of the first thermal cover 20. Four first electrode contacts 212 are assembled on the first circuit board 211 and respectively corresponding to the four pogo pin connectors 151, and two of the first electrode contacts 212 of the first triggering member 21 are electrically connected with each other to be in a conduction state (e.g., two of the first electrode contacts 212 are connected with each other via a connection wire 40). Please further refer to FIGS. 3 and 4. FIG. 4 illustrates a partial sectional view of the electronic device shown in FIG. 3. In this embodiment, the second triggering member 31 comprises a second circuit board 311 fixedly assembled on a side wall of the second thermal cover 30. Four second electrode contacts 312 are assembled on the second circuit board 311 and respectively corresponding to the four pogo pin connectors 151, and none of the four second electrode contacts 312 are electrically connected with each other. Therefore, as shown in FIGS. 1 and 2, when the first thermal cover 20 covers the chassis 10, the four pogo pin connectors 151 are respectively in contact with the four first electrode contacts 212 to generate a first digital signal. Conversely, as shown in FIGS. 3 and 4, when the second thermal cover 30 covers the chassis 10, the four pogo pin connectors 151 are respectively in contact with the four second electrode contacts 312 to generate a second digital signal. Since two of the first electrode contacts 212 of the first thermal cover 20 are electrically connected with each other and none of the second electrode contacts 312 of the second thermal cover 30 are electrically connected with each other, the first digital signal is different from the second digital signal (e.g., the first digital signal is a high voltage signal, and the second digital signal is a low voltage signal). In other words, the connection state between the recognition device 15 and the first triggering member 21 is different from the connection state between the recognition device 15 and the second triggering member 31. Consequently, the first digital signals and the second digital signals generated by the different connection states are different. Therefore, when the BIOS 12 detects the first digital signal, the BIOS 12 can identify the first thermal cover 20 covers the chassis 10; conversely, when the BIOS 12 detects the second digital signal, the BIOS 12 can identify the second thermal cover 30 covers the chassis 10. In another embodiment, none of the four first electrode contacts 212 of the first thermal cover 20 are electrically connected with each other, and some or all of the second electrode contacts 312 of the second thermal cover 30 are electrically connected with each other. Alternatively, some of the first electrode contacts 212 of the first thermal cover 20 are electrically connected with each other, and all of the second electrode contacts 312 of the second thermal cover 30 are electrically connected with each other. In a further option, some of the first electrode contacts 212 of the first thermal cover 20 are electrically connected with each other, some of the second electrode contacts 312 of the second thermal cover 30 are electrically connected with each other, and the number of the connected electrode contacts of the first electrode contacts 212 is different from that of the second electrode contacts 312 (e.g., three of the first electrode contacts 212 of the first thermal cover 20 are electrically connected with each other, and two of the second electrode contacts 312 of the second thermal cover 30 are electrically connected with each other). Accordingly, these illustrated embodiments make the connection state between the recognition device 15 and the first triggering member 21 be different from the connection state between the recognition device 15 and the second triggering member 31, so that the different connection states generate different first and second digital signals.

Please refer to FIGS. 1 and 3. In one embodiment, the I/O module 14 may be an analog I/O module and can be controlled by programs (e.g., the analog I/O module may be controlled by PLC (programmable logic controller) programs written in 8051 language), so that the I/O module 14 generates different analog signals according to the connection state of the recognition device 15 (i.e., the recognition device 15 is connected to the first triggering member 21 or the second triggering member 31). Alternatively, the I/O module 14 may be a digital I/O module and can be controlled by programs (e.g., the digital I/O module may be controlled by PLC programs written in 8051 language), so that the I/O module 14 generates different digital signals according to the connection state of the recognition device 15 (i.e., the recognition device 15 is connected to the first triggering member 21 or the second triggering member 31). For example, the I/O module 14 may be a general-purpose I/O module (GPIO), and each of the pins of the I/O module 14 is at a first bit value, “0” or a second bit value, “1”, according to the connection state of the recognition device 15 respectively connected with the first triggering member 21 or the second triggering member 31. When the first thermal cover 20 covers the chassis 10 (as shown in FIG. 1), the I/O module 14 corresponds to the connection state between the recognition device 15 and the first triggering member 21 to perform a first bit value (e.g., the first bit value is 0); conversely, when the second thermal cover 30 covers the chassis 10 (as shown in FIG. 3), the I/O module 14 corresponds to the connection state between the recognition device 15 and the second triggering member 31 to perform a second bit value (e.g., the second bit value is 1). Accordingly, when the BIOS 12 detects the I/O module 14 performing a first bit value, the BIOS 12 can identify the first thermal cover 20 is covering the chassis 10; while when the BIOS 12 detects the I/O module 14 performing a second bit value, the BIOS 12 can identify the second thermal cover 30 is covering the chassis 10.

Please refer to FIGS. 1 to 4 as well as Table 1 below.

TABLE 1

| | | | Connection |
|---|---|---|---|
| GPIO1 | GPIO2 | GPIO3 | state |
| 0 | 0 | 0 | 1 |
| 0 | 0 | 1 | 2 |
| 0 | 1 | 0 | 3 |
| 0 | 1 | 1 | 4 |
| 1 | 0 | 0 | 5 |
| 1 | 0 | 1 | 6 |
| 1 | 1 | 0 | 7 |
| 1 | 1 | 1 | 8 |

If the I/O module 14 has three groups of pins (as the GPIO1, GPIO2, and GPIO3 shown in Table 1), the I/O module 14 would correspond to up to eight different connection states and being adapted to eight different thermal covers. In detail, taking the embodiment illustrated in FIGS. 1 and 2 as an example, supposed that the pin of the I/O module 14 performs a bit value of 0 to the first electrode contact 212 in a conduction state and performs a bit value of 1 to the first electrode contact 212 not in a conduction state, in this embodiment, since the second one and the third one of the first electrode contacts 212 of the first triggering member 21 are connected with each other, and the first one and the fourth one of the first electrode contacts 212 of the first triggering member 21 are not connected with each other, the GPIO1, the GPIO2, and the GPIO3 respectively generate bit values of “1 0 1” in order, indicating the first triggering member 21 and the recognition device 15 correspond to the connection state 6 shown in Table 1. Consequently, when the first one and the second one of the first electrode contacts 212 of the first triggering member 21 are connected with each other, the first triggering member 21 and the recognition device 15 correspond to the connection state 4 shown in Table 1 (i.e., the GPIO1, the GPIO2, and the GPIO3 respectively generate bit values of “0 1 1” in order). When the third one and the fourth one of the first electrode contacts 212 of the first triggering member 21 are connected with each other, the first triggering member 21 and the recognition device 15 correspond to the connection state 7 shown in Table 1 (i.e., the GPIO1, the GPIO2, and the GPIO3 respectively generate bit values of “1 1 0” in order). When the first one, the second one, and the third one of the first electrode contacts 212 of the first triggering member 21 are connected with each other, the first triggering member 21 and the recognition device 15 correspond to the connection state 2 shown in Table 1 (i.e., the GPIO1, the GPIO2, and the GPIO3 respectively generate bit values of “0 0 1” in order). When the first one, the third one, and the fourth one of the first electrode contacts 212 of the first triggering member 21 are connected with each other, the first triggering member 21 and the recognition device 15 correspond to the connection state 3 shown in Table 1 (i.e., the GPIO1, the GPIO2, and the GPIO3 respectively generate bit values of “0 1 0” in order). When the second one, the third one, and the fourth one of the first electrode contacts 212 of the first triggering member 21 are connected with each other, the first triggering member 21 and the recognition device 15 correspond to the connection state 5 shown in Table 1 (i.e., the GPIO1, the GPIO2, and the GPIO3 respectively generate bit values of “1 0 0” in order). When all of the first electrode contacts 212 of the first triggering member 21 are connected with each other, the first triggering member 21 and the recognition device 15 correspond to the connection state 1 shown in Table 1 (i.e., the GPIO1, the GPIO2, and the GPIO3 respectively generate bit values of “0 0 0” in order). As shown in FIG. 4, in this embodiment, all of the second electrode contacts 312 of the second triggering member 31 are not connected with each other, and the second triggering member 31 and the recognition device 15 correspond to the connection state 8 shown in Table 1 (i.e., the GPIO1, the GPIO2, and the GPIO3 respectively generate bit values of “1 1 1” in order). Accordingly, when the I/O module 14 has three groups of pins, the I/O module 14 can be adapted to eight different thermal covers, and the BIOS 12 can identify which of the thermal covers is assembled to the chassis 10 according to different connection states. It is understood that, the I/O module 14 may have more than three groups of pins to correspond to more connection states and to be adapted to more than eight different thermal covers.

As above, as shown in FIGS. 1 and 3, in this embodiment, the electronic component 13 may comprise a memory unit 131 (e.g., a register or a memory). The memory unit 131 respectively stores the bit values corresponding to different connection states (for example, connection states 1 to 8) generated by the I/O module 14. Therefore, according to the bit value stored in the memory unit 131 of the electronic component 13, the BIOS 12 can identify which of the thermal covers is assembled to the chassis 10 so as to drive the electronic component 13 to be operated according to the corresponding operation parameter.

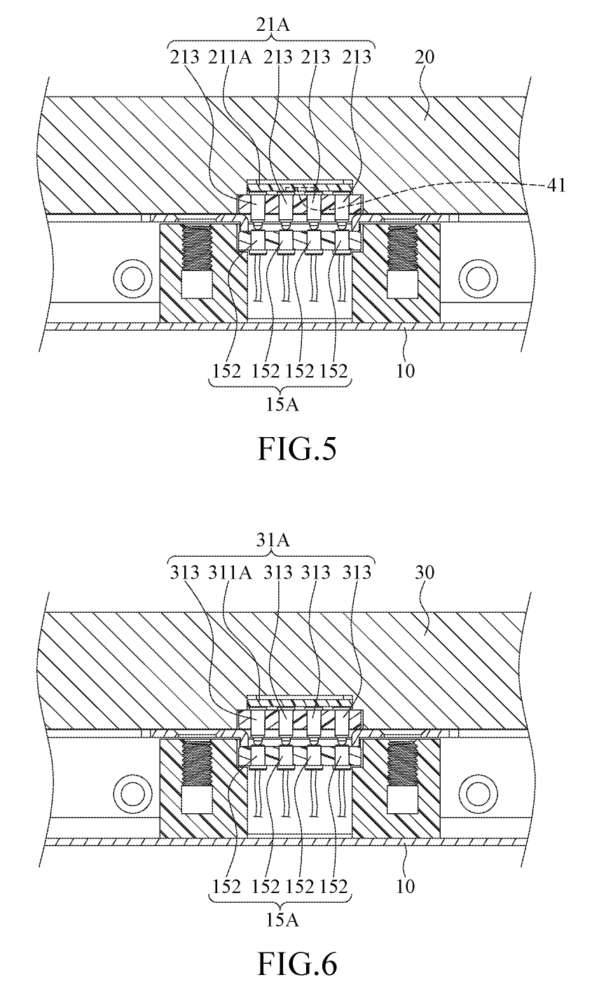

Please refer to FIGS. 5 and 6, illustrating partial sectional view (1) and (2) of an electronic device according to a second embodiment of the instant disclosure. In this embodiment, the recognition device 15A comprises four conductive contacts 152. As shown in FIG. 5, the first triggering member 21A of the first thermal cover 20 comprises a first circuit board 211A, four first pogo pin connectors 213 are assembled on the first circuit board 211A and respectively correspond to the four conductive contacts 152, and two of the first pogo pin connectors 213 of the first triggering member 21A are electrically connected with each other to be in a conduction state (for example, two of the first pogo pin connectors 213 are connected with each other via a connection wire 41). As shown in FIG. 6, the second triggering member 31A of the second thermal cover 30 comprises a second circuit board 311A, four second pogo pin connectors 313 are assembled on the second circuit board 311A and respectively correspond to the four conductive contacts 152, and none of the four second pogo pin connectors 313 are electrically connected with each other. Therefore, as shown in FIG. 5, when the first thermal cover 20 covers the chassis 10, the four conductive contacts 152 are respectively in contact with the four first pogo pin connectors 213 to generate a first digital signal. Conversely, as shown in FIG. 6, when the second thermal cover 30 covers the chassis 10, the four conductive contacts 152 are respectively in contact with the four second pogo pin connectors 313 to generate a second digital signal. Since two of the first pogo pin connectors 213 of the first thermal cover 20 are electrically connected with each other and none of the second pogo pin connectors 313 of the second thermal cover 30 are electrically connected with each other, the first digital signal is different from the second digital signal. Therefore, when the BIOS 12 detects the first digital signal, the BIOS 12 can identify the first thermal cover 20 covers the chassis 10; conversely, when the BIOS 12 detects the second digital signal, the BIOS 12 can identify the second thermal cover 30 covers the chassis 10. In another embodiment, none of the four pogo pin connectors 213 of the first thermal cover 20 are electrically connected with each other, and some or all of the second pogo pin connectors 313 of the second thermal cover 30 are electrically connected with each other. Alternatively, some of the first pogo pin connectors 213 of the first thermal cover 20 are electrically connected with each other, and all of the second pogo pin connectors 313 of the second thermal cover 30 are electrically connected with each other. In a further option, some of the first pogo pin connectors 213 of the first thermal cover 20 are electrically connected with each other, some of the second pogo pin connectors 313 of the second thermal cover 30 are electrically connected with each other, and the number of the connected connectors of the first pogo pin connectors 213 is different from that of the second pogo pin connectors 313. Accordingly, these illustrated embodiments can generate different first and second digital signals.

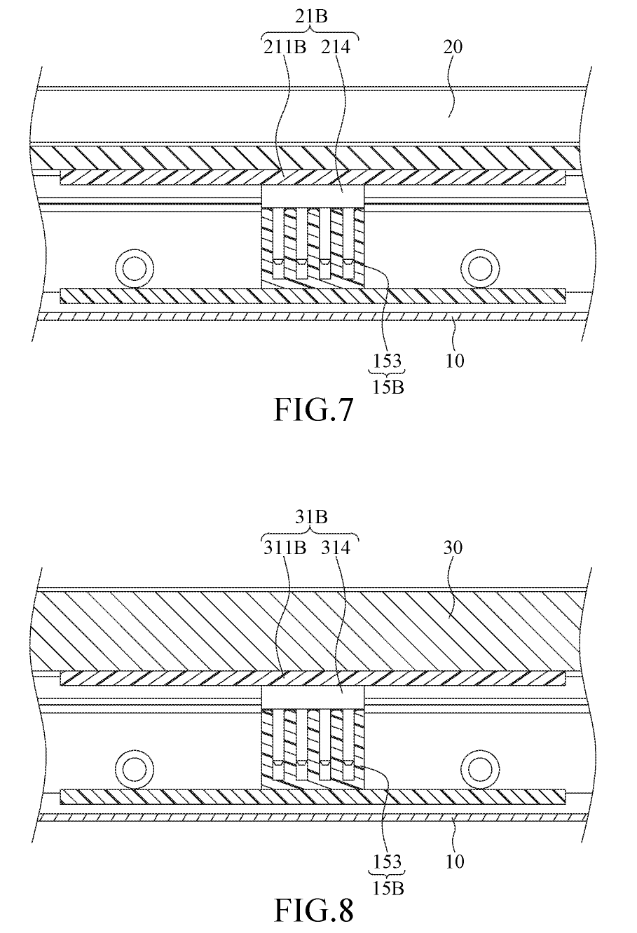

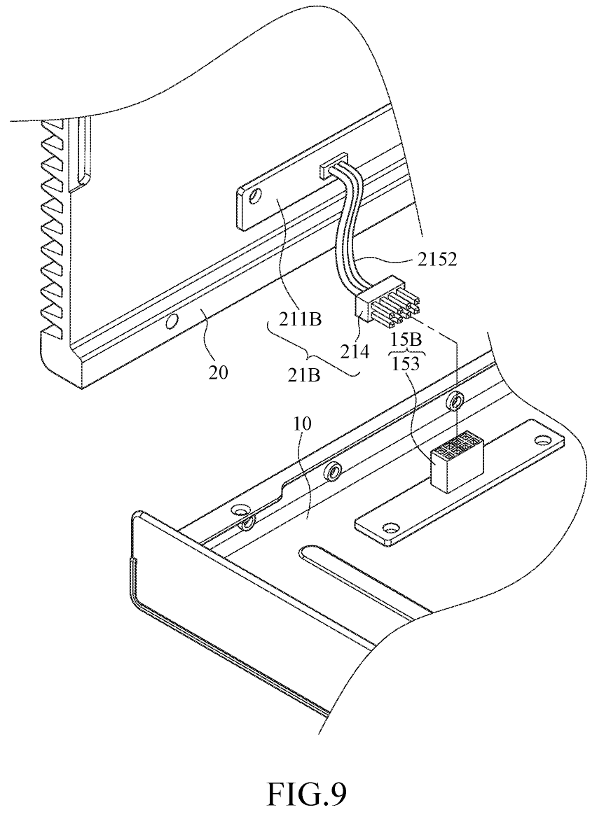

Please refer to FIGS. 7 and 8, illustrating partial sectional views (1) and (2) of an electronic device according to a third embodiment of the instant disclosure. In this embodiment, the recognition device 15B comprises a receptacle connector 153. As shown in FIG. 7, the first triggering member 21B of the first thermal cover 20 comprises a first circuit board 211B and a first plug connector 214 fixedly assembled on the first circuit board 211B and corresponding to the receptacle connector 153. As shown in FIG. 8, the second triggering member 31B of the second thermal cover 30 comprises a second circuit board 311B and a second plug connector 314 fixedly assembled on the second circuit board 311B and corresponding to the receptacle connector 153. As shown in FIG. 7, when the first thermal cover 20 covers the chassis 10, the first plug connector 214 is correspondingly connected to the receptacle connector 153, and the first circuit board 211B outputs a first signal automatically. As shown in FIG. 8, when the second thermal cover 30 covers the chassis 10, the second plug connector 314 is correspondingly connected to the receptacle connector 153, and the second circuit board 311B outputs a second signal automatically. For example, the circuit layout of the first circuit board 211B is different from that of the second circuit board 311B; e.g., the first circuit board 211B and the second circuit board 311B may have different signal controllers or logic circuits so as to output different first and second signals. Therefore, when the BIOS 12 detects the first signal, the BIOS 12 can identify the first thermal cover 20 covers the chassis 10; conversely, when the BIOS 12 detects the second signal, the BIOS 12 can identify the second thermal cover 30 covers the chassis 10. Wherein, the first circuit board 211B and the second circuit board 311B may be assembled with batteries or may receive electricity from the motherboard 11, for outputting the first signal and the second signal, respectively. Further, as shown in FIG. 9, in this embodiment, the first plug connector 214 of the first triggering member 21B of the first thermal cover 20 is connected to the first circuit board 211B via a first wire 2152. Accordingly, prior to covering the first thermal cover 20 on the chassis 10, the first plug connector 214 is connected to the receptacle connector 153 so as to ensure the connection between the first plug connector 214 and the receptacle connector 153. The second plug connector 314 may be connected to the second circuit board 311B via a wire (not shown).

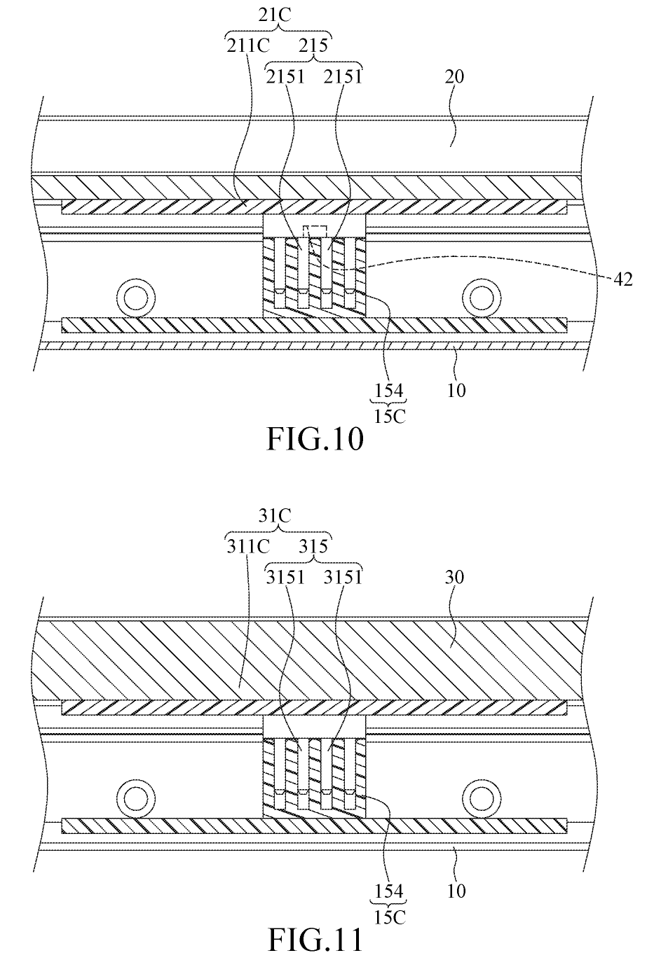

Please refer to FIGS. 10 and 11, illustrating partial sectional views (1) and (2) of an electronic device according to a fourth embodiment of the instant disclosure. In this embodiment, the recognition device 15C comprises a receptacle connector 154. As shown in FIG. 10, the first triggering member 21C of the first thermal cover 20 comprises a first circuit board 211C and a first plug connector 215 fixedly assembled on the first circuit board 211C. Wherein, the first plug connector 215 comprises a plurality of first connection terminals 2151, and two of the first connection terminals 2151 are electrically connected with each other to be in a conduction state (e.g., two of the first connection terminals 2151 are electrically connected with each other via a connection wire 42). As shown in FIG. 11, the second triggering member 31C of the second thermal cover 30 comprises a second circuit board 311C and a second plug connector 315 fixedly assembled on the second circuit board 311C. Wherein, the second plug connector 315 comprises a plurality of second connection terminals 3151, and none of the second connection terminals 3151 are electrically connected with each other. Therefore, as shown in FIG. 10, when the first thermal cover 20 covers the chassis 10, the first plug connector 215 is correspondingly connected to the receptacle connector 154 to generate a first digital signal. Conversely, as shown in FIG. 11, when the second thermal cover 30 covers the chassis 10, the second plug connector 315 is correspondingly connected to the receptacle connector 154 to generate a second digital signal. Since two of the first connection terminals 2151 of the first plug connector 215 are electrically connected with each other and none of the second connection terminals 3151 of the second plug connector 315 are electrically connected with each other, the first digital signal is different from the second digital signal (e.g., the first digital signal is a high voltage signal, and the second digital signal is a low voltage signal). Therefore, when the BIOS 12 detects the first digital signal, the BIOS 12 can identify the first thermal cover 20 covers the chassis 10; conversely, when the BIOS 12 detects the second digital signal, the BIOS 12 can identify the second thermal cover 30 covers the chassis 10. In other embodiments, none of the first connection terminals 2151 of the first thermal cover 20 are electrically connected with each other, and some or all of the second connection terminals 3151 of the second thermal cover 30 are electrically connected with each other. Alternatively, some of the first connection terminals 2151 of the first thermal cover 20 are electrically connected with each other, and all of the second connection terminals 3151 of the second thermal cover 30 are electrically connected with each other. In a further option, some of the first connection terminals 2151 of the first thermal cover 20 are electrically connected with each other, some of the second connection terminals 3151 of the second thermal cover 30 are electrically connected with each other, and the number of the connected terminals of the first connection terminals 2151 is different from that of the second connection terminals 3151. Accordingly, these illustrated embodiments can generate different first and second digital signals.

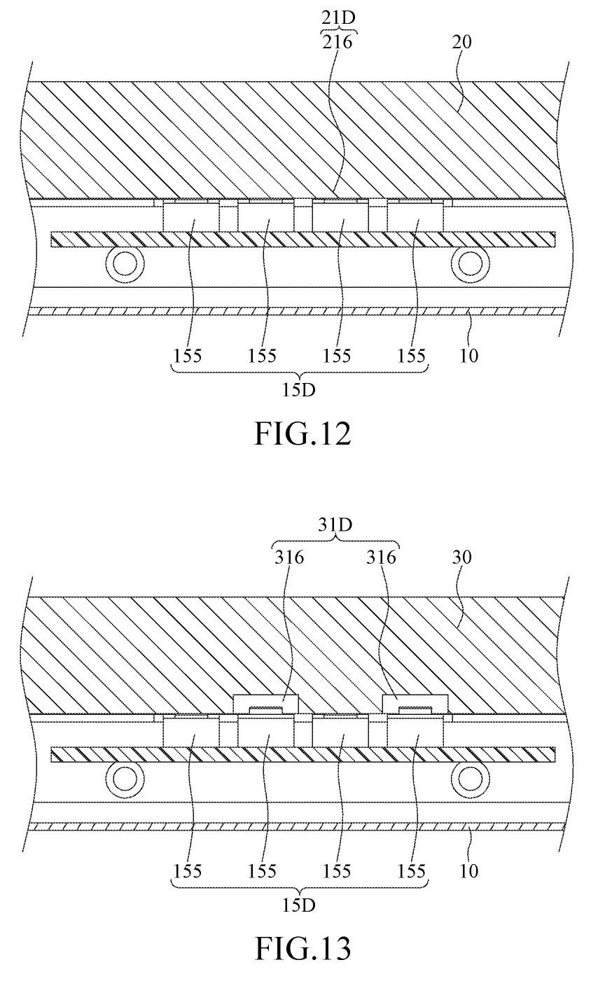

As shown in FIGS. 12 and 13, illustrating partial sectional views (1) and (2) of an electronic device according to a fifth embodiment of the instant disclosure. In this embodiment, the recognition device 15D may comprise one or more button switches 155. For the sake of convenience, in this embodiment, the recognition device 15D comprises four button switches 155. As shown in FIG. 12, the first triggering member 21D is a pressing block 216 corresponding to the four button switches 155. In this embodiment, the pressing block 216 is one of the side walls of the first thermal cover 20. When the first thermal cover 20 covers the chassis 10, the pressing block 216 presses all of the button switches 155 to generate a first digital signal. As shown in FIG. 13, the second triggering member 31D of the second thermal cover 30 is one of the side walls of the second thermal cover 30, and two recesses 316 are recessed from the second triggering member 31D. The two recesses 316 correspond to two of the button switches 155. Therefore, when the second thermal cover 30 covers the chassis 10, only two of the button switches 155 are pressed and the rest two button switches 155 are not pressed by the portions of the side wall comprising the two recesses 316. Accordingly, a second digital signal is can be generated. Since the number of the button switches 155 pressed by the first thermal cover 20 is different from the number of the button switches 155 pressed by the second thermal cover 30, the first digital signal is different from the second digital signal (e.g., the first digital signal is a high voltage signal, and the second digital signal is a low voltage signal). Therefore, when the BIOS 12 detects the first digital signal, the BIOS 12 can identify the first thermal cover 20 covers the chassis 10; conversely, when the BIOS 12 detects the second digital signal, the BIOS 12 can identify the second thermal cover 30 covers the chassis 10. To conclude, the first triggering member 21D and the second triggering member 31D may respectively press on different button switches 155, on button switches155 with different combinations, or on button switches 155 with different numbers. Therefore, the BIOS 12 can detect and identify which of the thermal covers is assembled to the chassis 10.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An electronic device, comprising:
A chassis assembled with a motherboard and a recognition device, wherein the motherboard comprises a basic input/output system (BIOS) and an electronic component, the BIOS is electrically connected to the electronic component, a first operation parameter and a second operation parameter which are adapted to the electronic component are preset in the BIOS;
a first thermal cover comprising a first triggering member; and
a second thermal cover comprising a second triggering member, wherein a heat dissipation capacity of the first thermal cover is different from a heat dissipation capacity of the second thermal cover;
wherein, the first thermal cover or the second thermal cover selectively covers the chassis, when the first thermal cover covers the chassis, the first triggering member corresponds to the recognition device, and the BIOS detects a connection state between the recognition device and the first triggering member to drive the electronic component to be operated according to the first operation parameter; when the second thermal cover covers the chassis, the second triggering member corresponds to the recognition device, and the BIOS detects a connection state between the recognition device and the second triggering member to drive the electronic component to be operated according to the second operation parameter.

2. The electronic device according to claim 1, wherein the recognition device comprises two pogo pin connectors, the first triggering member comprises a first circuit board, two first electrode contacts are assembled on the first circuit board and electrically connected with each other, the second triggering member comprises a second circuit board, two second electrode contacts are assembled on the second circuit board and not electrically connected with each other, the two first electrode contacts or the two second electrode contacts are selectively in contact with the two pogo pin connectors, respectively.

3. The electronic device according to claim 1, wherein the recognition device comprises two conductive contacts, the first triggering member comprises a first circuit board, the first circuit board is assembled with two first pogo pin connectors electrically connected with each other, the second triggering member comprises a second circuit board, the second circuit board is assembled with two second pogo pin connectors not electrically connected with each other, the two first pogo pin connectors or the two second pogo pin connectors are selectively in contact with the two conductive contacts, respectively.

4. The electronic device according to claim 1, wherein the recognition device comprises at least one button switch, the first triggering member comprises at least one pressing block corresponding to the at least one button switch, the second triggering member comprises at least one recess corresponding to the at least one button switch.

5. The electronic device according to claim 1, wherein the recognition device comprises a receptacle connector, the first triggering member comprises a first circuit board and a first plug connector connected to the first circuit board, the second triggering member comprises a second circuit board and a second plug connector connected to the second circuit board, when the first thermal cover covers the chassis, the first plug connector is connected to the receptacle connector, and the first circuit board outputs a first signal related to the first operation parameter, when the second thermal covers the chassis, the second plug connector is connected to the receptacle connector, and the second circuit board outputs a second signal related to the second operation parameter.

6. The electronic device according to claim 5, wherein the first plug connector is connected to the first circuit board by a first wire and the second plug connector is connected to the second circuit board by a second wire.

7. The electronic device according to claim 5, wherein the first plug connector is fixedly assembled on the first circuit board, the second plug connector is fixedly assembled on the second circuit board, and the receptacle connector is fixedly assembled in the chassis and selectively corresponds to the first plug connector or the second plug connector.

8. The electronic device according to claim 1, wherein the recognition device comprises a receptacle connector, the first triggering member comprises a first circuit board and a first plug connector connected to the first circuit board, the first plug connector comprises two first connection terminals electrically connected with each other, the second triggering member comprises a second circuit board and a second plug connector connected to the second circuit board, the second plug connector comprises two second connection terminals not electrically connected with each other.

9. The electronic device according to claim 1, wherein the motherboard further comprises an input/output module (I/O module), the I/O module is electrically connected to the recognition device and the BIOS, respectively, wherein when the first thermal cover covers the chassis, the I/O module performs a first bit value, when the second thermal cover covers the chassis, the I/O module performs a second bit value.

10. The electronic device according to claim 9, wherein the electronic component comprises a memory unit, the electronic component is electrically connected to the I/O module, the memory unit selectively stores the first bit value or the second bit value.

11. The electronic device according to claim 1, wherein an operation speed of the electronic component according to the first operation parameter is different from an operation speed of the electronic component according to the second operation parameter.

12. The electronic device according to claim 1, wherein the electronic component is a central processing unit, a display card, a memory, or a heat dissipation fan.
